(19) United States
(12) Patent Application Publication
(10) Pub. No.: US 2021/0408590 A1
(43) Pub. Date: Dec. 30, 2021

(54) METHOD FOR MANUFACTURING SOLID ELECTROLYTE-CONTAINING LAYER, METHOD FOR MANUFACTURING SOLID-STATE BATTERY, AND SOLID-STATE BATTERY

(71) Applicant: TOYOTA JIDOSHA KABUSHIKI KAISHA, Toyota-shi (JP)

(72) Inventors: Hiroko KUWATA, Susono-shi (JP); Shin Ushiroda, Susono-shi (JP); Keita Niitani, Sunto-gun (JP); Masato Hozumi, Mishima-shi (JP)

(73) Assignee: TOYOTA JIDOSHA KABUSHIKI KAISHA, Toyota-shi (JP)

(21) Appl. No.: 17/345,537

(22) Filed: Jun. 11, 2021

(30) Foreign Application Priority Data
Jun. 30, 2020 (JP) 2020-112743

(51) Int. Cl. H01M 10/0565; H01M 10/058

(52) U.S. Cl. CPC H01M 10/0565; H01M 2300/0082; H01M 10/058

(57) ABSTRACT

A method for manufacturing a solid electrolyte-containing layer that is used in a solid-state battery is disclosed. The method includes forming the solid electrolyte-containing layer by using a slurry containing a boron hydride compound and an alkane compound having 5 or 6 carbon atoms.

### CROSS-REFERENCE TO RELATED APPLICATION

This application claims priority to Japanese Patent Application No. 2020-112743 filed on Jun. 30, 2020, incorporated herein by reference in its entirety.

### BACKGROUND

### 1. Technical Field

The present disclosure relates to a method for manufacturing a solid electrolyte-containing layer, a method for manufacturing a solid-state battery, and a solid-state battery.

### 2. Description of Related Art

A solid-state battery is a battery having a solid electrolyte layer between a positive electrode layer and a negative electrode layer, and has an advantage that simplification of a safety device can be easily attained in comparison with a liquid battery having an electrolytic solution containing a flammable organic solvent.

A boron hydride compound is known as a solid electrolyte used in the solid-state battery. For example, WO 2019/078130 discloses a method for manufacturing an all-solid-state battery including: coating or impregnating at least one of a positive electrode layer and a negative electrode layer with a solution obtained by dissolving a boron hydride compound in a solvent; and then removing the solvent to cause the boron hydride compound to precipitate. In addition, in Sangryun Kim et al., “A complex hydride lithium superionic conductor for high-energy-density all-solid-state lithium metal batteries”, NATURE COMMUNICATIONS, (2019)10:1081, 0.7Li(CB₉H₁₀)-0.3Li(CB₁₁H₁₂) is disclosed as the boron hydride compound.

### SUMMARY

In WO 2019/078130, the boron hydride compound is dissolved in the solvent, and then the solvent is removed to cause precipitation of the boron hydride compound. When the boron hydride compound is dissolved in the solvent, ion conductivity after precipitation may decrease.

The present disclosure provides a method for manufacturing a solid electrolyte-containing layer, a method for manufacturing a solid-state battery, and a solid-state battery in which a decrease in ion conductivity of a boron hydride compound can be suppressed.

The first aspect of the present disclosure provides a method for manufacturing a solid electrolyte-containing layer that is used in a solid-state battery. The method includes forming the solid electrolyte-containing layer by using a slurry containing a boron hydride compound and an alkane compound having 5 or 6 carbon atoms.

According to the first aspect of the present disclosure, the alkane compound is combined with the boron hydride compound, whereby it is possible to obtain a solid electrolyte-containing layer in which a decrease in ion conductivity of the boron hydride compound is suppressed.

In the first aspect of the present disclosure, the alkane compound may be a chain compound.

In the first aspect of the present disclosure the alkane compound may be a cyclic compound.

In the first aspect of the present disclosure, the alkane compound may contain at least one of pentane, cyclopentane, and isohexane.

In the first aspect of the present disclosure, the solid electrolyte-containing layer may be a positive electrode layer.

In the first aspect of the present disclosure, the solid electrolyte-containing layer may be a negative electrode layer.

In the first aspect of the present disclosure the solid electrolyte-containing layer may be a solid electrolyte layer.

In addition, the second aspect of the present disclosure provides a method for manufacturing a solid-state battery that includes a positive electrode layer, a negative electrode layer, and a solid electrolyte layer formed between the positive electrode layer and the negative electrode layer, at least one of the positive electrode layer, the negative electrode layer, and the solid electrolyte layer being a solid electrolyte-containing layer containing a boron hydride compound. The method includes manufacturing the solid electrolyte-containing layer by the method for manufacturing a solid electrolyte-containing layer described above.

According to the second aspect of the present disclosure, at least one of the positive electrode layer, the negative electrode layer, and the solid electrolyte layer is the solid electrolyte-containing layer containing the boron hydride compound, and further, the solid electrolyte-containing layer is manufactured by using the slurry containing the alkane compound, whereby it is possible to obtain a solid-state battery in which a decrease in ion conductivity of the boron hydride compound is suppressed.

In addition, the third aspect of the present disclosure provides a solid-state battery including a positive electrode layer, a negative electrode layer, and a solid electrolyte layer formed between the positive electrode layer and the negative electrode layer. At least one of the positive electrode layer, the negative electrode layer, and the solid electrolyte layer is a solid electrolyte-containing layer containing a boron hydride compound. The solid electrolyte-containing layer contains an alkane compound having 5 or 6 carbon atoms as a residual component.

According to the third aspect of the present disclosure, at least one of the positive electrode layer, the negative electrode layer, and the solid electrolyte layer is the solid electrolyte-containing layer containing the boron hydride compound, and further, the solid electrolyte-containing layer contains the alkane compound as the residual component, whereby it is possible to obtain a solid-state battery in which a decrease in ion conductivity of the boron hydride compound is suppressed.

In the third aspect of the present disclosure, the alkane compound may be a chain compound.

In the third aspect of the present disclosure the alkane compound may be a cyclic compound.

In the third aspect of the present disclosure, the alkane compound may contain at least one of pentane, cyclopentane, and isohexane.

In the third aspect of the present disclosure, the solid electrolyte-containing layer may be a positive electrode layer.

In the third aspect of the present disclosure, the solid electrolyte-containing layer may be a negative electrode layer.

In the third aspect of the present disclosure the solid electrolyte-containing layer may be a solid electrolyte layer.

In the present disclosure, it is possible to obtain a solid electrolyte-containing layer in which a decrease in ion conductivity of a boron hydride compound is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic cross-sectional view illustrating a method for manufacturing a solid electrolyte-containing layer in the present disclosure;

FIG. 1B is a schematic cross-sectional view illustrating the method for manufacturing the solid electrolyte-containing layer in the present disclosure;

FIG. 1C is a schematic cross-sectional view illustrating the method for manufacturing the solid electrolyte-containing layer in the present disclosure;

FIG. 2 is a flowchart illustrating a method for manufacturing a solid-state battery in the present disclosure; and

FIG. 3 is a schematic cross-sectional view illustrating the solid-state battery in the present disclosure.

### DETAILED DESCRIPTION OF EMBODIMENTS

Hereinafter, the present disclosure will be described in detail.

A. Method for Manufacturing Solid Electrolyte-Containing Layer

A method for manufacturing a solid electrolyte-containing layer in the present disclosure is a method for manufacturing a solid electrolyte-containing layer that is used in a solid-state battery. The method includes a step of forming the solid electrolyte-containing layer by using a slurry containing a boron hydride compound and an alkane compound having 5 or 6 carbon atoms.

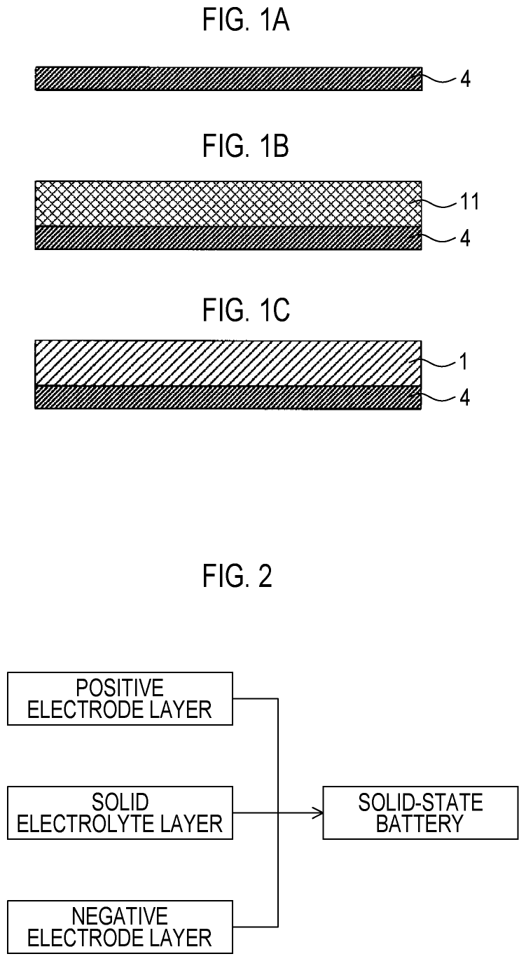

FIG. 1A to FIG. 1C are schematic cross-sectional views illustrating the method for manufacturing the solid electrolyte-containing layer in the present disclosure, and show a case where the solid electrolyte-containing layer is a positive electrode layer. First, a positive electrode current collector 4 is prepared (FIG. 1A). Next, the positive electrode current collector 4 is coated with a slurry containing a positive electrode active material, a boron hydride compound, and an alkane compound to form a coating layer 11 (FIG. 1B). Thereafter, the coating layer 11 is dried to remove the alkane compound, thereby forming a positive electrode layer 1 (FIG. 1C).

According to the present disclosure, the alkane compound is combined with the boron hydride compound, whereby it is possible to obtain a solid electrolyte-containing layer in which a decrease in ion conductivity of the boron hydride compound is suppressed. As described above, WO 2019/078130 discloses coating or impregnating at least one of a positive electrode layer and a negative electrode layer with a solution obtained by dissolving a boron hydride compound in a solvent, and then removing the solvent to cause the boron hydride compound to precipitate.

On the other hand, when the boron hydride compound is dissolved in the solvent, ion conductivity after precipitation may decrease. The reason is assumed as follows. That is, assumption is made that when the boron hydride compound is dissolved in the solvent, a strong interaction occurs between an anion component of the boron hydride compound and the solvent. As a result, assumption is made that ion conductivity of the boron hydride compound decreases due to an influence of the solvent even after precipitation.

With respect to this, in the present disclosure, the alkane compound is combined with the boron hydride compound, whereby it is possible to obtain a solid electrolyte-containing layer in which a decrease in ion conductivity of the boron hydride compound is suppressed. The reason is assumed as follows. That is, assumption is made that the alkane compound in the present disclosure does not dissolve the boron hydride compound, or even though the boron hydride compound is dissolved, the amount is extremely small, and therefore, the interaction that occurs between the anion component of the boron hydride compound and the solvent can be weakened. Furthermore, assumption is made that a bulkiness of the alkane compound is also a factor for weakening the interaction. Therefore, assumption is made that the decrease in ion conductivity of the boron hydride compound can be suppressed after precipitation. In addition, for example, in a case where an electrode layer (positive electrode layer or negative electrode layer) is manufactured as a solid electrolyte-containing layer, the alkane compound contained in the slurry can satisfactorily disperse an active material, and therefore, an electrode layer having favorable uniformity can be obtained.

The solid electrolyte-containing layer in the present disclosure is not particularly limited as long as it is a layer containing a boron hydride compound as a solid electrolyte, and typical examples of the solid electrolyte-containing layer include a positive electrode layer, a negative electrode layer, and a solid electrolyte layer.

1. Case where Solid Electrolyte-Containing Layer is Positive Electrode Layer

In this case, the slurry forming the positive electrode layer contains at least a positive electrode active material, a boron hydride compound, and an alkane compound. The slurry may further contain at least one of a conductive material and a binder, as needed.

(1) Solid Electrolyte

The slurry contains a boron hydride compound as a solid electrolyte. The boron hydride compound usually exists in a dispersed state in the slurry. In addition, the boron hydride compound refers to a compound having a cation component and an anion component having a B—H bond. Examples of the cation component include Li, Na, and K.

On the other hand, the anion component contains at least B and H. The anion component is usually a complex ion. The anion component may be a complex ion containing solely B and H, or may be a complex ion containing C in addition to B and H. Examples of the complex ion containing solely B and H include BH₄⁻, B₁₀H₁₀²⁻, and B₁₂H₁₂²⁻. On the other hand, examples of the complex ion containing B, H, and C include CB₉H₁₀⁻ and CB₁₁H₁₂⁻. The boron hydride compound may have solely one kind of anion component, or may have two or more kinds of anion components.

Examples of the boron hydride compound include LiCB₁₁H₁₂, LiCB₉H₁₀, Li₂B₁₂H₁₂, Li₂B₁₀H₁₀, LiBH₄, and a composite compound obtained by combining two or more kinds of the materials. The combination of the materials can be randomly selected. In particular, the boron hydride compound preferably has a composition represented by xLiCB₉H₁₀-(1-x)LiCB₉H₁₀ (0<x<1). This is because ion conductivity is high. x may be 0.2 or more, 0.4 or more, or 0.6 or more. On the other hand, x may be 0.9 or less, or 0.8 or less.

The boron hydride compound may or may not contain iodine (I). Similarly, the boron hydride compound may or may not contain phosphorus (P). Similarly, the boron hydride compound may or may not contain sulfur (S).

Examples of the boron hydride compound containing I include a compound having a composition represented by xLiBH₄-(1-x)LiI (0<x<1). x may be 0.6 or more and 0.9 or less. Examples of the boron hydride compound containing P and S include a compound having a composition represented by xLiBH₄-(1-x)P₂S₅ (0<x<1). x may be 0.7 or more and 0.95 or less. Examples of the boron hydride compound containing P and I include a compound having a composition represented by xLiBH₄-(1-x)P₂I₄ (0<x<1). x may be 0.7 or more and 0.95 or less. The slurry may contain solely one kind of boron hydride compound, or may contain two or more kinds of boron hydride compounds.

The slurry may contain solely a boron hydride compound, or may contain other materials, as a solid electrolyte. A proportion of the boron hydride compound in the entire solid electrolyte is, for example, 50% by weight or more, and may be 70% by weight or more, or 90% by weight or more. In addition, a proportion of the solid electrolyte in the total solid content of the slurry is, for example, 10% by weight or more, and may be 20% by weight or more, or 30% by weight or more. On the other hand, the proportion of the solid electrolyte is, for example, 70% by weight or less, and may be 60% by weight or less.

(2) Dispersion Medium

The slurry contains an alkane compound having 5 or 6 carbon atoms as a dispersion medium. The “alkane compound having 5 or 6 carbon atoms” refers to a chain saturated hydrocarbon represented by a general formula of CₙH₂ₙ₊₂ (n is 5 or 6), a cyclic saturated hydrocarbon represented by a general formula of CₙH₂ₙ (n is 5 or 6), and derivatives thereof.

The alkane compound may be a chain compound or a cyclic compound. Examples of the chain compound (chain alkane compound) include pentane (n-pentane), isopentane (2-methylbutane), hexane (n-hexane), isohexane (2-methylpentane), 3-methylpentane, diisopropyl (2,3-dimethylbutane), and neohexane (2,2-dimethylbutane). On the other hand, examples of the cyclic compound (cyclic alkane compound) include cyclopentane, cyclohexane, and methylcyclopentane. In addition, a carbon chain in the alkane compound may or may not have a branched structure.

In particular, the alkane compound is preferably pentane, cyclopentane, or isohexane. This is because the decrease in ion conductivity of the boron hydride compound can be suppressed. The slurry may contain solely one kind of alkane compound having 5 or 6 carbon atoms, or may contain two or more kinds of boron hydride compounds having 5 or 6 carbon atoms. In addition, a chain alkane compound and a cyclic alkane compound may be used in combination. A relative permittivity (25° C.) of the alkane compound is preferably two or less, for example. A vapor pressure (25° C.) of the alkane compound is preferably 20 kPa or more, for example.

The slurry may contain solely one kind of alkane compound having 5 or 6 carbon atoms, or may contain other materials, as a dispersion medium. A proportion of the alkane compound having 5 or 6 carbon atoms in the entire dispersion medium is, for example, 50% by weight or more, and may be 70% by weight or more, or 90% by weight or more. A solid content concentration of the slurry is, for example, 30% by weight or more, and may be 40% by weight or more, or 50% by weight or more. On the other hand, the solid content concentration of the slurry is, for example, 80% by weight or less, and may be 70% by weight or less.

(3) Positive Electrode Active Material

A positive electrode active material is not particularly limited, but typically includes an oxide active material and elemental sulfur. Examples of the oxide active material include a rock salt layer type active material, such as LiCoO₂, LiMnO₂, LiNiO₂, LiVO₂, and LiNi_{1/3}Co_{1/3}Mn_{1/3}O₂, a spinel type active material, such as LiMn₂O₄ and Li(Ni_{0.5}Mn_{1.5})O₄, and an olivine type active material, such as LiFePO₄, LiMnPO₄, LiNiPO₄, and LiCuPO₄.

Examples of the shape of the positive electrode active material include a particulate shape. An average particle size (D₅₀) of the positive electrode active material is, for example, 0.1 μm or more and 50 μm or less. The average particle size can be calculated from, for example, measurement by a laser diffraction type particle size distribution meter or a scanning electron microscope (SEM). A proportion of the positive electrode active material in the total solid content of the slurry is, for example, 50% by weight or more, and may be 60% by weight or more. On the other hand, the proportion of the positive electrode active material is, for example, 80% by weight or less.

(4) Slurry

The slurry may contain a conductive material. Addition of the conductive material improves electron conductivity of the solid electrolyte-containing layer. Examples of the conductive material include acetylene black, Ketjen black, and carbon fiber. In addition, the slurry may contain a binder. Addition of the binder improves denseness of the solid electrolyte-containing layer. Examples of the binder include a fluorine binder, such as a PVDF binder, a rubber binder, and an acrylic binder. In addition, the slurry may contain an additive, such as a thickener and a dispersant, as needed.

As a method for preparing the slurry, a method for kneading the positive electrode active material, the boron hydride compound, and the alkane compound is exemplified. Examples of the kneading method include an ultrasonic homogenizer, a shaker, a thin film rotation mixer, a dissolver, a homomixer, a kneader, a roll mill, a sand mill, an attritor, a ball mill, a vibrator mill, and a high-speed impeller mill.

(5) Method for Forming Positive Electrode Layer

As a method for forming the positive electrode layer, a method having a coating treatment of coating a base material with a slurry to form a coating layer and a drying treatment of drying the coating layer to form a positive electrode layer is exemplified. Examples of the method for performing coating with the slurry include a doctor blade method, a die coating method, a gravure coating method, a spray coating method, an electrostatic coating method, and a bar coating method.

The base material coated with the slurry is not particularly limited, but examples of the base material include a positive electrode current collector. A positive electrode having favorable adhesion between the positive electrode current collector and the positive electrode layer can be obtained by coating the positive electrode current collector with the slurry. Examples of the material of the positive electrode current collector include SUS, aluminum, nickel, iron, titanium, and carbon.

The method for drying the coating layer is not particularly limited, but examples of the method include a general method, such as warm air/hot air drying, infrared drying, vacuum drying, and dielectric heating drying. As a dry atmosphere, an inert gas atmosphere, such as an Ar gas atmosphere and a nitrogen gas atmosphere, an air atmosphere, and a vacuum are exemplified. In particular, the method for drying the coating layer is preferably vacuum-drying with heat. A drying temperature is not particularly limited, and is preferably a temperature at which the material contained in the coating layer does not deteriorate. After the coating layer is dried, a press treatment may be performed, as needed. Examples of the press treatment include a press treatment for densifying the positive electrode layer.

A thickness of the positive electrode layer is, for example, 0.1 μm or more. On the other hand, the thickness of the positive electrode layer is, for example, 1000 μm or less, and may be 300 μm or less.

2. Case where Solid Electrolyte-Containing Layer is Negative Electrode Layer

In this case, the slurry forming the negative electrode layer contains at least a negative electrode active material, a boron hydride compound, and an alkane compound. The slurry may further contain at least one of a conductive material and a binder, as needed.

The negative electrode active material is not particularly limited, but examples of the negative electrode active material include a carbon active material, a metal active material, and an oxide active material. Examples of the carbon active material include graphite, hard carbon, and soft carbon. On the other hand, examples of the metal active material include a simple substance, such as Li, Si, In, Al, and Sn, and an alloy containing at least one of these elements. Examples of the oxide active material include SiO and Li₄T₁₅O₁₂. Examples of the shape of the negative electrode active material include a particulate shape. An average particle size (D₅₀) of the negative electrode active material is, for example, 0.1 μm or more and 50 μm or less. A proportion of the negative electrode active material in the total solid content of the slurry is, for example, 30% by weight or more, and may be 50% by weight or more. On the other hand, the proportion of the negative electrode active material is, for example, 80% by weight or less.

Other matters related to the boron hydride compound, the alkane compound, the conductive material, the binder, and the slurry are basically the same as those described in “1. Case where Solid Electrolyte-Containing Layer Is Positive Electrode Layer” above, and therefore, the descriptions thereof are omitted.

As a method for forming the negative electrode layer, a method having a coating treatment of coating a base material with a slurry to form a coating layer and a drying treatment of drying the coating layer to form a negative electrode layer is exemplified. The content is basically the same as that described in “1. Case where Solid Electrolyte-Containing Layer Is Positive Electrode Layer” above except that the negative electrode active material is used instead of the positive electrode active material, and therefore, the description thereof is omitted. In a case where the base material coated with the slurry is a negative electrode current collector, examples of the material of the negative electrode current collector include SUS, copper, nickel, and carbon.

A thickness of the negative electrode layer is, for example, 0.1 μm or more. On the other hand, the thickness of the negative electrode layer is, for example, 1000 μm or less, and may be 300 μm or less.

3. Case where Solid Electrolyte-Containing Layer is Solid Electrolyte Layer

In this case, the slurry forming the solid electrolyte layer (separator layer) contains at least a boron hydride compound and an alkane compound. The slurry may further contain a binder, as needed.

Other matters related to the boron hydride compound, the alkane compound, the binder, and the slurry are basically the same as those described in “1. Case where Solid Electrolyte-Containing Layer Is Positive Electrode Layer” above, and therefore, the descriptions thereof are omitted. A proportion of the solid electrolyte in the total solid content of the slurry is, for example, 80% by weight or more, and may be 90% by weight or more, or 95% by weight or more.

As a method for forming the solid electrolyte layer, a method having a coating treatment of coating a base material with a slurry to form a coating layer and a drying treatment of drying the coating layer to form a solid electrolyte layer is exemplified. The content is basically the same as that described in “1. Case where Solid Electrolyte-Containing Layer Is Positive Electrode Layer” above except that the positive electrode active material and the conductive material are not used, and therefore, the description thereof is omitted. Examples of the base material coated with the slurry include at least one of a positive electrode layer and a negative electrode layer. In addition, as the base material, a base material for transfer may be used. In this case, it is preferable to form the solid electrolyte layer on the base material for transfer, bring the obtained solid electrolyte layer into contact with the positive electrode layer or the negative electrode layer, and then peel off the base material for transfer.

A thickness of the solid electrolyte layer is, for example, 0.1 μm or more. On the other hand, the thickness of the solid electrolyte layer is, for example, 1000 μm or less, and may be 300 μm or less.

B. Method for Manufacturing Solid-State Battery

FIG. 2 is a flowchart illustrating a method for manufacturing the solid-state battery in the present disclosure. The method for manufacturing the solid-state battery shown in FIG. 2 includes a positive electrode layer forming step of forming a positive electrode layer, a negative electrode layer forming step of forming a negative electrode layer, and a solid electrolyte layer forming step of forming a solid electrolyte layer. In the present disclosure, at least one of the positive electrode layer, the negative electrode layer, and the solid electrolyte layer is a solid electrolyte-containing layer containing a boron hydride compound, and the solid electrolyte-containing layer is manufactured by the method described in “A. Method for Manufacturing Solid Electrolyte-Containing Layer” above.

According to the present disclosure, at least one of the positive electrode layer, the negative electrode layer, and the solid electrolyte layer is the solid electrolyte-containing layer containing the boron hydride compound, and further, the solid electrolyte-containing layer is manufactured by using the slurry containing the alkane compound, whereby it is possible to obtain a solid-state battery in which a decrease in ion conductivity of the boron hydride compound is suppressed.

In the present disclosure, any one layer of the positive electrode layer, the negative electrode layer, and the solid electrolyte layer may be a solid electrolyte-containing layer, two layers of the positive electrode layer, the negative electrode layer, and the solid electrolyte layer may be solid electrolyte-containing layers (two layers can be selected in any combination), and all layers of the positive electrode layer, the negative electrode layer, and the solid electrolyte layer may be solid electrolyte-containing layers. The method for manufacturing the solid electrolyte-containing layer is the same as that described in “A. Method for Manufacturing Solid Electrolyte-Containing Layer” above, and therefore, the description thereof is omitted.

The method for manufacturing the solid-state battery in the present disclosure may include, in addition to the above-described steps (positive electrode layer forming step, negative electrode layer forming step, and solid electrolyte layer forming step), a lamination step of laminating a positive electrode layer, a solid electrolyte layer, and a negative electrode layer in this order to form a power generation element. The lamination method is not particularly limited, and any method can be adopted. In addition, as needed, the power generation element may be subjected to a press treatment. The characteristics of the obtained solid-state battery will be described in “C. Solid-State Battery” described below.

C. Solid-State Battery

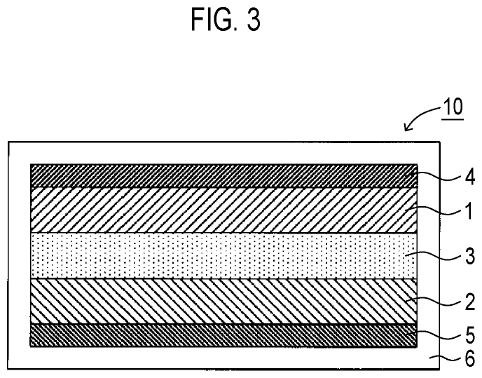

FIG. 3 is a schematic cross-sectional view illustrating the solid-state battery in the present disclosure. A solid-state battery 10 shown in FIG. 3 includes a positive electrode layer 1, a negative electrode layer 2, a solid electrolyte layer 3 formed between the positive electrode layer 1 and the negative electrode layer 2, a positive electrode current collector 4 that collects current from the positive electrode layer 1, a negative electrode current collector 5 that collects current from the negative electrode layer 2, and a battery case 6 that houses these members. At least one of the positive electrode layer 1, the negative electrode layer 2, and the solid electrolyte layer 3 is a solid electrolyte-containing layer containing a boron hydride compound. Further, the solid electrolyte-containing layer contains an alkane compound having 5 or 6 carbon atoms as a residual component.

According to the present disclosure, at least one of the positive electrode layer, the negative electrode layer, and the solid electrolyte layer is the solid electrolyte-containing layer containing the boron hydride compound, and further, the solid electrolyte-containing layer contains the alkane compound as the residual component, whereby it is possible to obtain a solid-state battery in which a decrease in ion conductivity of the boron hydride compound is suppressed. In other words, the solid electrolyte-containing layer is manufactured by using the slurry containing the alkane compound described above, whereby it is possible to obtain a solid-state battery in which a decrease in ion conductivity of the boron hydride compound is suppressed.

The residual component in the present disclosure is a dispersion medium that remains in a case where the solid electrolyte-containing layer is formed by using the slurry containing the alkane compound described above. The presence of the residual component can be confirmed, for example, by heating a sample and measuring a released gas by gas chromatography. From the viewpoint of battery performance, it is preferable that the amount of the residual component contained in the layer is small. The amount of the residual component is, for example, 20000 ppm or less, and may be 10000 ppm or less. On the other hand, a lower limit of the amount of the residual component need only be higher than a detection limit. This is because side reaction due to the residual component can be suppressed.

In the present disclosure, any one layer of the positive electrode layer, the negative electrode layer, and the solid electrolyte layer may be a solid electrolyte-containing layer, two layers of the positive electrode layer, the negative electrode layer, and the solid electrolyte layer may be solid electrolyte-containing layers (two layers can be selected in any combination), and all layers of the positive electrode layer, the negative electrode layer, and the solid electrolyte layer may be solid electrolyte-containing layers.

The solid-state battery in the present disclosure usually includes the positive electrode layer, the negative electrode layer, and the solid electrolyte layer. These layers are the same as those described in “A. Method for Manufacturing Solid Electrolyte-Containing Layer” above, and therefore, the descriptions thereof are omitted. In addition, the solid-state battery is preferably a lithium ion battery. The solid-state battery may be a primary battery or a secondary battery, but is preferably a secondary battery. This is because the battery can be repeatedly charged and discharged, and is useful as an in-vehicle battery, for example. Examples of the shape of the solid-state battery include a coin type, a laminate type, a cylindrical type, and a square type.

The present disclosure is not limited to the embodiment. The embodiment is an example, and anything having substantially the same structure as the technical idea described in the claims of the present disclosure and exhibiting the similar operation and effect is included in the technical scope of the present disclosure.

### Experimental Example 1

Synthesis of Solid Electrolyte

LiCB₉H₁₀.H₂O (manufactured by Katchem Ltd.) and LiCB₁₁H₁₂.0.5H₂O (manufactured by Katchem Ltd.) were vacuum-dried at 160° C. for 12 hours. The two dried powders were weighed in a molar ratio of LiCB₉H₁₀:LiCB₁₁H₁₂=7:3, and mixed in a mortar for 15 minutes. The resultant mixture was added to a zirconia pot, and a crushing ball was also added. The pot was sealed, placed on a planetary ball mill, and subjected to a mechanical milling treatment at 400 rpm for 20 hours. Thereafter, mixing was performed in a mortar for 15 minutes, thereby obtaining a boron hydride compound (solid electrolyte).

Preparation of Solid Electrolyte for Evaluation

The resultant solid electrolyte was immersed in pentane, dispersed by a homogenizer for 30 seconds, and allowed to rest for 10 seconds. This cycle was performed 10 times. Thereafter, when the state of the solid electrolyte was visually confirmed, confirmation was made that the solid electrolyte remained as particles in pentane. Then, a dispersion (a mixture of a solid electrolyte and pentane) was added to a glass petri dish and dried on a hot plate at 100° C. for one hour, thereby obtaining a solid electrolyte for evaluation.

### Experimental Examples 2 to 5 and Comparative Experimental Examples 1 to 3

A solid electrolyte for evaluation was obtained in the same manner as in Experimental Example 1 except that cyclopentane (Experimental Example 2), isohexane (Experimental Example 3), hexane (Experimental Example 4), cyclohexane (Experimental Example 5), heptane (Comparative Experimental Example 1), butyl butyrate (Comparative Experimental Example 2), and N-methyl-2-pyrrolidone (Comparative Experimental Example 3) were used instead of pentane.

Evaluation

A voltage of ±10 mV was applied to each of the solid electrolytes for evaluation obtained in Experimental Examples 1 to 5 and Comparative Experimental Examples 1 to 3, and a resistance value was measured in a range of 0.01 Hz to 1 MHz. Ion conductivity was calculated using the measured resistance value and a thickness of the solid electrolyte. In addition, ion conductivity was calculated in the same manner using the solid electrolyte before being immersed in a liquid, and a maintenance rate of ion conductivity was obtained. The results are shown in Table 1. Maintenance rate of ion conductivity (0%)=(ion conductivity after immersion)/(ion conductivity before immersion)×100

TABLE 1

| | | Presence or absence | Maintenance |
|---|---|---|---|
| | | of residual solid | rate of ion |
| | Liquid | electrolyte particle | conductivity (%) |
| Experimental | Pentane | Presence | 76 |
| Example 1 | (C₅H₁₂) | | |
| Experimental | Cyclopentane | Presence | 78 |
| Example 2 | (C₅H₁₀) | | |
| Experimental | Isohexane | Presence | 73 |
| Example 3 | (C₆H₁₄) | | |
| Experimental | Hexane | Presence | 57 |
| Example 4 | (C₆H₁₄) | | |
| Experimental | Cyclohexane | Presence | 22 |
| Example 5 | (C₆H₁₂) | | |
| Comparative | Heptane | Presence | 0.08 |
| Experimental | (C₇H₁₆) | | |
| Example 1 | | | |
| Comparative | Butyl butyrate | Absence | Unmeasurable |
| Experimental | (C₈H₁₆O₂) | | |
| Example 2 | | | |
| Comparative | N-methyl-2- | Presence | Unmeasurable |
| Experimental | pyrrolidone | | |
| Example 3 | (C₅H₉NO) | | |

As shown in Table 1, the maintenance rate of ion conductivity in Experimental Examples 1 to 5 was higher than that in Comparative Experimental Examples 1 to 3. In particular, in Experimental Examples 1 to 3, the maintenance rate of ion conductivity was particularly favorable. The reason is not completely clear, but it is assumed that the alkane compounds used in Experimental Examples 1 to 3 were easily removed by drying because of a high vapor pressure of the alkane compound. As described above, confirmation was made that use of the alkane compound can suppress the decrease in ion conductivity of the boron hydride compound.

On the other hand, in Comparative Experimental Example 1, heptane that is an alkane was used, but the maintenance rate of ion conductivity was low. The reason is not completely clear, but it is assumed that heptane was not sufficiently removed by drying because a vapor pressure of heptane was lower than the vapor pressure of the alkane compounds used in Experimental Examples 1 to 5. In addition, it is assumed that heptane changed a structure of the boron hydride compound (solid electrolyte).

### Experimental Examples 6 to 10

A solid electrolyte for evaluation was obtained in the same manner as in Experimental Examples 1 to 5 except that vacuum-drying at 100° C. was performed instead of drying on a hot plate at 100° C.

Evaluation

Using the solid electrolytes for evaluation obtained in Experimental Examples 6 to 10, the maintenance rate of ion conductivity was obtained in the same manner as described above. The results are shown in Table 2.

TABLE 2

| | | Maintenance |
|---|---|---|
| | | rate of ion at |
| | | conductivity by |
| | | vacuum-drying |
| | Liquid | 100° C. (%) |
| Experimental | Pentane (C₅H₁₂) | 110 |
| Example 6 | | |
| Experimental | Cyclopentane (C₅H₁₀) | 95 |
| Example 7 | | |
| Experimental | Isohexane (C₆H₁₄) | 87 |
| Example 8 | | |
| Experimental | Hexane (C₆H₁₄) | 98 |
| Example 9 | | |
| Experimental | Cyclohexane (C₆H₁₂) | 33 |
| Example 10 | | |

Comparing Table 2 with Table 1 described above, Experimental Examples 6 to 10 had higher maintenance rates of ion conductivity than Experimental Examples 1 to 5, respectively. From this, it was suggested that the amount of the alkane compound that remains in the solid electrolyte is preferably small. In particular, in Experimental Example 6, ion conductivity exceeded 100%. The reason is assumed that because pentane had a particularly high vapor pressure and a high affinity with water, water that remains in the solid electrolyte also volatilized together with heptane.

What is claimed is:

1. A method for manufacturing a solid electrolyte-containing layer that is used in a solid-state battery, the method comprising forming the solid electrolyte-containing layer by using a slurry containing a boron hydride compound and an alkane compound having 5 or 6 carbon atoms.

2. The method according to claim 1, wherein the alkane compound is a chain compound.

3. The method according to claim 1, wherein the alkane compound is a cyclic compound.

4. The method according to claim 1, wherein the alkane compound contains at least one of pentane, cyclopentane, and isohexane.

5. The method according to claim 1, wherein the solid electrolyte-containing layer is a positive electrode layer.

6. The method according to claim 1, wherein the solid electrolyte-containing layer is a negative electrode layer.

7. The method according to claim 1, wherein the solid electrolyte-containing layer is a solid electrolyte layer.

8. A method for manufacturing a solid-state battery that includes a positive electrode layer, a negative electrode layer, and a solid electrolyte layer formed between the positive electrode layer and the negative electrode layer, at least one of the positive electrode layer, the negative electrode layer, and the solid electrolyte layer being a solid electrolyte-containing layer containing a boron hydride compound, the method comprising manufacturing the solid electrolyte-containing layer by the method for manufacturing a solid electrolyte-containing layer according to claim 1.

9. A solid-state battery comprising:
a positive electrode layer;
a negative electrode layer; and
a solid electrolyte layer formed between the positive electrode layer and the negative electrode layer, wherein:
at least one of the positive electrode layer, the negative electrode layer, and the solid electrolyte layer is a solid electrolyte-containing layer containing a boron hydride compound; and
the solid electrolyte-containing layer contains an alkane compound having 5 or 6 carbon atoms as a residual component.

10. The solid-state battery according to claim 9, wherein the alkane compound is a chain compound.

11. The solid-state battery according to claim 9, wherein the alkane compound is a cyclic compound.

12. The solid-state battery according to claim 9, wherein the alkane compound contains at least one of pentane, cyclopentane, and isohexane.

13. The solid-state battery according to claim 9, wherein the solid electrolyte-containing layer is a positive electrode layer.

14. The solid-state battery according to claim 9, wherein the solid electrolyte-containing layer is a negative electrode layer.

15. The solid-state battery according to claim 9, wherein the solid electrolyte-containing layer is a solid electrolyte layer.
